(19) United States
(12) Patent Application Publication
(10) Pub. No.: US 2006/0214437 A1
(43) Pub. Date: Sep. 28, 2006

(54) Door jamb socket plug

(76) Inventor: Yaron Farzan, Tel Aviv (IL)

Correspondence Address: YARON FARZAN, Shlomo Hamelekh 6, Tel Aviv, 64377, IL

(21) Appl. No.: 11/357,001

(22) Filed: Feb. 21, 2006

(30) Foreign Application Priority Data
Mar. 22, 2005 (IL) 167497

(51) Int. Cl. E05B 15/02

(52) U.S. Cl. 292/340

(57) ABSTRACT

The device of the present invention is a door jamb socket plug that has a flat surface and a shaped body that fits into a door jamb socket. When installed into a door jamb socket, the door jamb socket plug prevents a door from latching, by not allowing the door lock latch bolt to enter into the door jamb socket.

### BACKGROUND

The objective of the device of this invention is to allow a door to close while preventing said door from latching. The door jamb socket plug does so by acting as a barrier between the door lock latch bolt and the door jamb socket. Latching occurs when a door lock latch bolt enters a door jamb socket. When the door lock latch bolt is pushed back into the door lock chamber by gliding over the door jamb socket plug, the door lock is neutralized from latching the door.

This invention is useful wherever doors are frequently used or need to be readily available for opening and closing. For example, in the workplace, where personnel carry material from one room to another. A door jamb socket plug is useful anywhere there is inability to turn or reach a door knob or handle. Is it useful in medical institutions, where staff can have their hands free while giving patients mobile medical attention. It is useful in children's' or elderly people's rooms.

An invention with a similar objective that is now on the market is a device that incorporates a button or a lever that, when pushed, holds or locks the latch bolt inside the lock chamber and stops the latch bolt from springing out from the door lock. Installing said device of this invention means replacing a door lock mechanism with a technically more complex one, which requires periodic maintenance and is more vulnerable to breakdowns. This device is relatively costly, and proper installation thereof requires a skilled artisan.

The preferred embodiment of the present invention takes the form of a one-piece device that is easy to install, easy to use, easy to maintain, removable, transferable, and cheap to produce. Other embodiments of the present invention may take the form of more than one piece.

### SUMMARY OF THE INVENTION

The objective of the present invention is to prevent a door from latching while allowing said door to close and open without having to turn the door knob or handle. The door jamb socket plug is employed by inserting the shaped body of the door jamb socket plug into a door jamb socket. The device of the present invention takes the form of a) a door jamb socket plug comprising a flat surface that prevents entry into a door jamb socket; and b) a shaped body that fits into said door jamb socket, as follows.
a) The flat surface of the device of the present invention can come in any shape, such as a rectangle, a square, a circle, a triangle, or any other geometric or organic shape, such as animal or novelty shapes, etc. When door jamb socket plug is installed, the flat surface thereof should be flush with the door jamb surface, or protrude, but not beyond the space between the door and the door jamb. It should be flat enough to allow easeful closure of the door.
b) The shaped body of the device of the present invention can come in any shape, whether geometric or organic. It is, of course, preferable that the shaped body of the door jamb socket plug perfectly fits the door jamb socket; however, is can also be made of malleable material so that if it does not fit perfectly it can be shaped with a cutting utensil, such as an exacto knife.

The device of the present invention can be made of any material firm enough to push the door lock latch bolt back into the door lock chamber and prevent it from entering the door jamb socket. The material should also be durable to withstand repetitive use. The preferred material is firm rubber, rubber silicon or an equivalent polymer. Rigid plastic and metal are also appropriate materials. Materials that are somewhat malleable are also appropriate for the purpose of re-shaping the shaped body of the door jamb socket plug to fit the door jamb socket.

The first preferred embodiment is a door jamb socket plug consisting of a) a flat surface with a sloped edge along each of its lengths; b) a shaped body consisting of protrusions that are cone-shaped, tilted outwards from the center of the device and have a ribbed surface; and c) removing slits cut into the sides of the flat surface, as follows.
a) The first preferred embodiment has a flat surface with sloped edges along each of its lengths to allow smooth gliding of the door lock latch bolt over the installed door jamb socket plug. The sloped edges of the flat surface face in the direction from which the door lock latch bolt comes to glide over the flat surface. The edges are sloped along both lengths of the preferred embodiment to permit using the device from either side. The edges of the flat surface of the preferred embodiment of the door jamb socket plug extend beyond the shaped body. When door jamb socket plug is installed, the flat surface of the preferred embodiment should completely cover the door jamb socket.
b) The first preferred embodiment also has a shaped body consisting of protrusions that are cone-shaped, ribbed and tilted outwards from the device center. The protrusions are located on the underside of the flat surface of the door jamb socket plug and on each corner thereof. The cone-shaped protrusions are widest where they connect with the underside of the flat surface of the door jamb socket plug. The tilted, cone-shaped protrusions start protruding a distance away from the edges of the corners of the underside of the door jamb socket plug and taper off to the imaginary external corners thereof. The tilt and the ribbed surface of the protrusions allow for extra traction, and grip the inside walls of the door jamb socket when the preferred embodiment is installed. The ribbed, tilted protrusions firmly hug the walls of the door jamb socket to secure the device into place and prevent it from sliding out.
c) The first preferred embodiment also has removing apparatuses in the form of slits cut into the sides of the underside of the flat surface and allow easy release of the door jamb socket plug from the door jamb socket. Release of the door jamb plug from the door jamb socket can be achieved by sliding a fingernail or a flat apparatus into one of the removing slits and pulling away from the door jamb socket.

A second preferred embodiment is a door jamb socket plug with the same features of the first preferred embodiment except that the removing apparatus is in the form of a flat handle or a pull tab, provided that said apparatus is located in an area of the door jamb socket plug that does not prevent or disturb the gliding of the door lock latch bolt over the door jamb socket plug.

A third preferred embodiment is a door jamb socket plug with the same features of the first preferred embodiment except that the surface of the door jamb socket plug does not extend beyond the door jamb socket boundaries, and can be installed in a reversed position into the door jamb socket. When desired, this feature of reversibility allows the door lock latch bolt to enter the door jamb socket, thereby latching the door while providing a natural storage place for the door jamb socket plug.

### BRIEF DESCRIPTION OF THE DRAWINGS

FIG. 1 is a general view of the first preferred embodiment.

FIG. 2 is side view of the first preferred embodiment.

FIG. 3 is a another side view of the first preferred embodiment.

FIG. 4 is a top view of the first preferred embodiment.

FIG. 5 is a bottom view of the first preferred embodiment.

FIG. 6 is a view of
a) a door;
b) a door lock latch bolt;
c) a door jamb;
d) a door jamb socket.

FIG. 7 is a top cross-sectional view of the first preferred embodiment installed in the door jamb socket and of the door lock latch bolt when door is ajar.

FIG. 8 is a top cross-sectional view of the installed first preferred embodiment when door is closed and the door lock latch bolt glides over the door jamb socket plug and is pushed inside the door lock chamber.

FIG. 9
a) is a view of
   1. a door lock mechanism;
   2. a door lock latch bolt;
   3. a door jamb socket.
b) is a view of
   1. the first preferred embodiment situated outside the door jamb socket;
   2. the arrow illustrates the direction of installing the door jamb socket plug into the door jamb socket;
c) is a view of a door lock latch bolt gliding over the first preferred embodiment that is installed into the door jamb socket;
d) is a view of the door lock latch bolt pushed inside the door lock mechanism as the door jamb socket plug prevents said door lock latch bolt from entering the door jamb socket.

### DETAILED DESCRIPTION OF THE DRAWINGS

The following is an explanation based on the drawings of an embodiment of this invention.

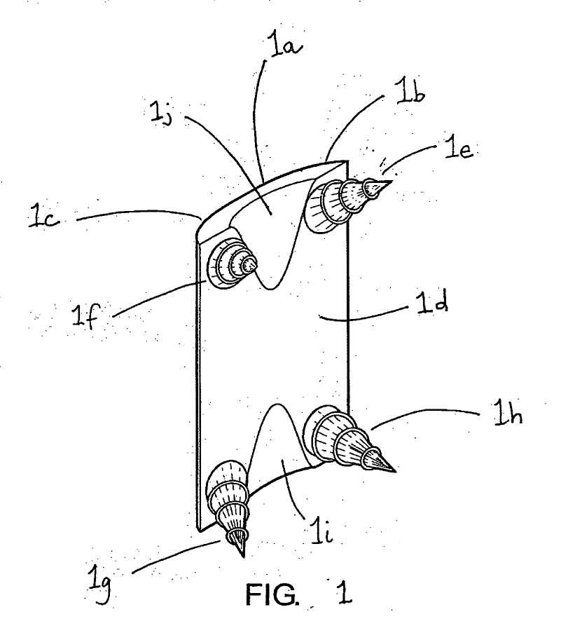

A door jamb socket plug as the first embodiment of this invention is shown in FIGS. 1-9.

FIG. 1 shows the first preferred embodiment and its physical features: a flat surface 1a with sloped edges 1b-1c, an underside id to flat surface 1a, protrusions 1e-1h that are cone-shaped, ribbed and tilted, and removing apparatuses 1i-1j cut into the sides of the underside of flat surface 1a. Protrusions 1e-1h comprise the shaped body of the first preferred embodiment.

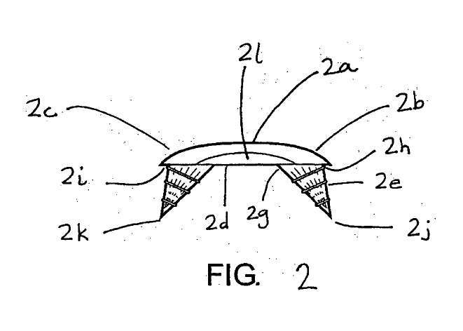

FIG. 2 is a side view of the first preferred embodiment showing a flat surface 2a, sloped edges 2b-2c of flat surface 2a, an underside 2d to flat surface 2a, and protrusions 2e-2f located on the underside 2d of flat surface 2a. The protrusions are widest 2g where they connect to underside 2d of flat surface 2a and start to protrude a distance away from corners 2h-2i of underside 2d. The protrusions also taper off to the imaginary external corners 2j-2k of underside 2d. A removing slit 2l is cut into side of underside 2d.

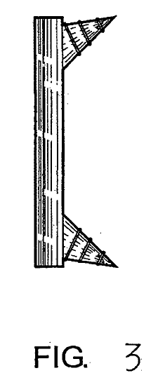

FIG. 3 reiterates FIG. 2, but without showing the removing apparatuses of the preferred embodiment.

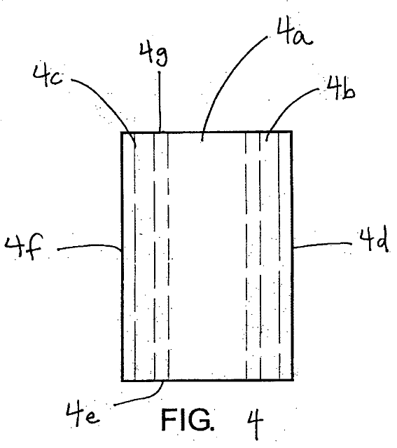

FIG. 4 is a top view of the first preferred embodiment consisting of a flat surface 4a and sloped edges 4b-4c of flat surface 4a. Since in the first preferred embodiment the edges 4d-4f of flat surface 4a extend beyond shaped body, the shaped body is not visible in this view.

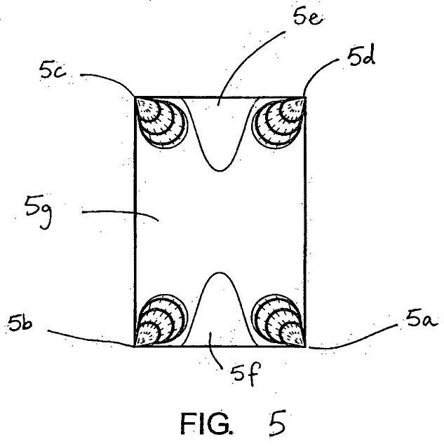

FIG. 5 is a view of the underside of the preferred embodiment and shaped body. This view clearly shows that protrusions 5a-5d are tilted outwards from the device center and taper off to the imaginary corners of the underside 5g. Removing slits 5e-5f of the preferred embodiment cut into the sides of underside 5g.

A door lock latch bolt 6b springs out from the door lock mechanism 6f. In FIG. 6, view of door jamb socket 6d is obstructed by door jamb socket plug 6a. Usually, when closing a door 6h, the door lock latch bolt comes in contact with the door jamb 6c, is pushed back into the door lock chamber inside door lock mechanism 6f, but springs out again into the door jamb socket 6d, thereby latching the door. When the door jamb socket plug 6a is installed, the door lock latch bolt 6b is prevented from entering the door jamb socket 6d. (The door remains unlocked, since door lock dead bolt 6g remains within door lock mechanism 6f and does not enter door jamb socket 6e. When door jamb socket plug is installed into door jamb socket 6e, door lock dead bolt is also prevented from entry into said door jamb socket.)

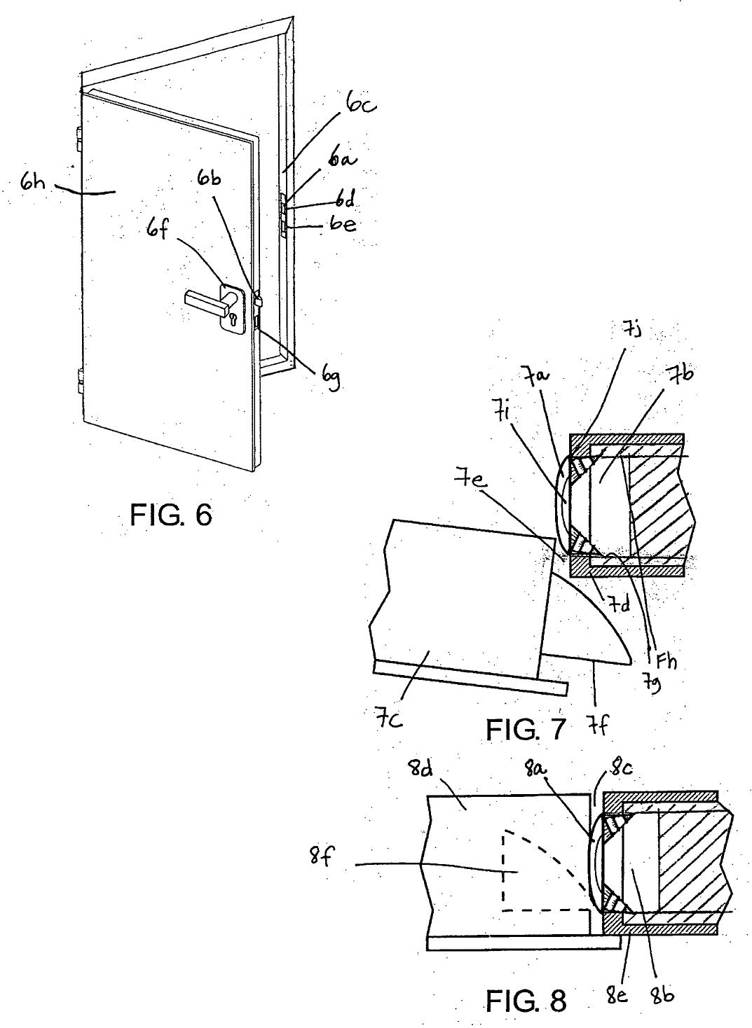

FIG. 7 shows a cross-sectional view of the preferred embodiment of the door jamb socket plug 7a installed in door jamb socket 7b. The flat surface 7j of the door jamb socket plug 7a protrudes, but not beyond the space 7e between door 7c and door jamb 7d. Door lock latch bolt 7f springs out from door lock mechanism. The protrusions 7g-7h, which are cone-shaped, tilted and ribbed, hug the walls 7i of the door jamb socket 7b. Removing slit 7i of preferred embodiment is visible. The flat surface 7j of the door jamb socket plug 7a covers door jamb socket.

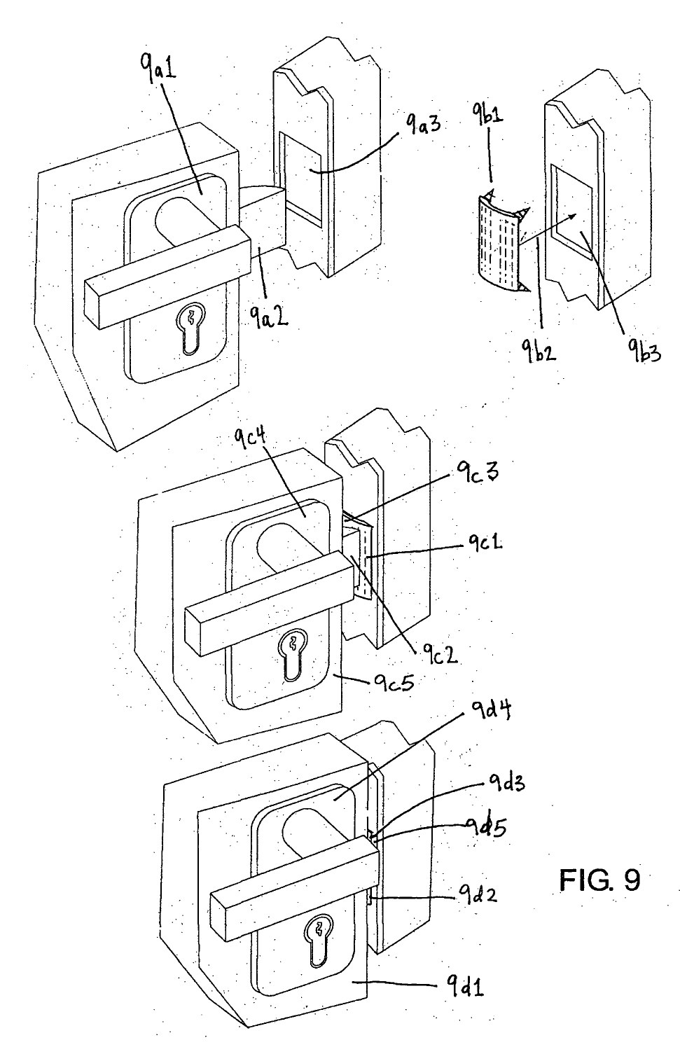

FIG. 8 shows a cross-sectional view of the preferred embodiment of the door jamb socket plug 8a installed in door jamb socket 8b. The flat surface of the door jamb socket plug protrudes, but not beyond the space 8c between door 8d and door jamb 8e, allowing the door to close fully. The installed door jamb socket plug 8a pushes door lock latch bolt 8f into door lock mechanism and prevents it from entering door jamb socket 8b, thereby the door is allowed to close, but not latch.

In FIG. 9, door lock mechanism 9a1 and door lock latch bolt 9a2 stand against door jamb socket 9a3. When door jamb socket plug is not installed, door lock latch bolt 9a2 can enter the door jamb socket 9a3.

Door jamb socket plug 9b1 is employed by inserting shaped body (see protrusions 1e-1h of preferred embodiment) of said door jamb socket plug into door jamb socket 9b3. Arrow 9b2 shows the direction in which to install door jamb socket plug 9b1 into door jamb socket 9b3.

Sloped edge 9c1 of the installed preferred embodiment face in the direction from which the door lock latch bolt 9c2 comes to glide over flat surface 9c3. The sloped edge 9c1 allows door lock latch bolt 9c2 to easily glide over flat surface 9c3. The door closes, 9c5 and door lock latch bolt 9c2 is being pushed into door lock mechanism 9c4.

The action of closing a door 9d1 while preventing it from latching is completed. The installed door jamb socket plug 9d2 has pushed door lock latch bolt 9d3 (not visible) back into the door lock mechanism 9d4. Door jamb socket plug 9d2 acts as a barrier between door lock latch bolt 9d3 and the door jamb socket 9d5 (not visible). The door 9d1 is now closed, but not latched.

Description

This invention relates to a door jamb socket plug the objective of which is to prevent a door from latching while still allowing said door to close. When installed into a door jamb socket, the flat surface of the door jamb socket plug prevents the door lock latch bolt to enter said door jamb socket. The body of the door jamb socket plug firmly installs into the door jamb socket.

What is claimed is:

1. A door jamb socket plug comprising:
a) a flat surface
b) a shaped body

2. A door jamb socket plug as defined in claim 1, wherein the flat surface is of any shape.

3. A door jamb socket plug as defined in claim 2, wherein the flat surface has sloped edges.

4. A door jamb socket plug as defined in claim 3, wherein the edges of the flat surface extend beyond the shaped body.

5. A door jamb socket plug as defined in claim 1, wherein the shaped body is of any shape.

6. A door jamb socket plug as defined in claim 5, wherein the shaped body is inserted into a door jamb socket.

7. A door jamb socket plug as defined in claim 6, wherein the flat surface completely covers door jamb socket.

8. A door jamb socket plug as defined in claim 7, wherein the flat surface is flush with the door jamb surface, or protrudes, but not beyond the space between the door and the door jamb.

9. A door jamb socket plug as defined in claim 8, wherein the sloped edges of the flat surface face in the direction from which the door lock latch bolt comes to glide over the flat surface.

10. A door jamb socket plug as defined in claim 5, wherein the shaped body protrudes from the underside of the flat surface.

11. A door jamb socket plug as defined in claim 10, wherein the shaped body comes in the form of several protrusions.

12. A door jamb socket plug as defined in claim 11, wherein the protrusions are cone-shaped.

13. A door jamb socket plug as defined in claim 12, wherein the protrusions are widest where they touch the underside of the flat surface of the door jamb socket plug.

14. A door jamb socket plug as defined in claim 13, wherein the protrusions are tilted outwards from the device center.

15. A door jamb socket plug as defined in claim 14, wherein the protrusions are located at each corner of the underside of the flat surface of the door jamb socket plug.

16. A door jamb socket plug as defined in claim 15, wherein the protrusions start protruding a distance away from the edges of the corner of the underside of the door jamb socket plug and taper out to imaginary external corners thereof.

17. A door jamb socket plug as defined in claim 16, wherein the protrusions are ribbed.

18. A door jamb socket plug as defined in claim 1, wherein removing apparatuses are built into the sides of underside of the flat surface.

19. A door jamb socket plug as defined in claim 18, wherein the removing apparatuses are in the form of slits, flat handles or pull tabs.

20. A door jamb socket plug as defined in claim 1 made of firm yet somewhat malleable material, such as rubber or silicon rubber.

21. A door jamb socket plug as defined in claim 1 made of hard material, such as plastic or metal.

22. A door jamb socket plug as defined in claim 1 comprised of more than one component.

23. A door jamb socket plug as defined in claim 1, wherein the flat surface does not extend beyond its shaped body.

24. A door jamb socket plug as defined in claim 22, wherein the device may be installed in a reverse position into the door jamb socket.
